(19) United States
(12) Patent Application Publication
(10) Pub. No.: US 2005/0094484 A1
(43) Pub. Date: May 5, 2005

(54) Feeding device

(76) Inventor: Franz-Josef kl. Sextro, Vechta (DE)

Correspondence Address: GUDRUN E. HUCKETT DRAUDT, LONSSTR. 53, WUPPERTAL, 42289, DE

(21) Appl. No.: 10/496,600

(22) PCT Filed: Nov. 26, 2002
(86) PCT No.: PCT/EP02/13258

(30) Foreign Application Priority Data
Dec. 14, 2001 (DE) 201 20 281.6

(51) Int. Cl. B01F 15/06

(52) U.S. Cl. 366/144

(57) ABSTRACT

A feeding device has a feed mixing container with an agitator for mixing feed components and for circulating the feed components. At least one a UV radiation source is arranged in the interior of the feed mixing container for UV irradiation of inner surfaces of the feed mixing container and of a surface of the feed components possibly present in the feed mixing container. The at least one UV radiation source emits a UV radiation in the range of approximately 240 to 280 nanometers, has a power draw of approximately 30 to 40 watt, and is provided with a protective quartz glass cover.

The invention relates to a feeding device comprising a feed mixing container as it is used especially for feed devices for liquid feed. Feed mixing containers of this kind include an agitator for mixing the supplied feed components as well as for circulating the feed material in the container and are generally closed at the top by a cover that can be removed entirely or partially or can be swung open. Downstream of the feed mixing container there are conveying conduits to consumer locations.

The invention relates to the problem of improving the hygienic conditions in the feed in the container before, during and/or after feed processing. The invention solves this problem by a feeding device having the features of claim 1. With regard to further configurations, reference is being had to claims 2 to 19.

The feeding device according to the invention makes it possible to completely or largely sterilize the container interior after a cleaning process by killing off germs. Such a sterilization process can also be performed before carrying out a mixing process in order to kill off germs that remained during standstill times in the empty container and are subject to reproduction. Finally and particularly, such a germ-killing treatment can be performed also during a feed mixing process in order to reduce the number of germs in the feed components. A treatment of completely prepared feed mixtures in the container can be expedient during resting phases in order to delay or prevent the growth of germ numbers.

Further details and effects result from the following description and the drawing in which several embodiments of the subject matter of the invention are illustrated in more detail. The drawing shows in:

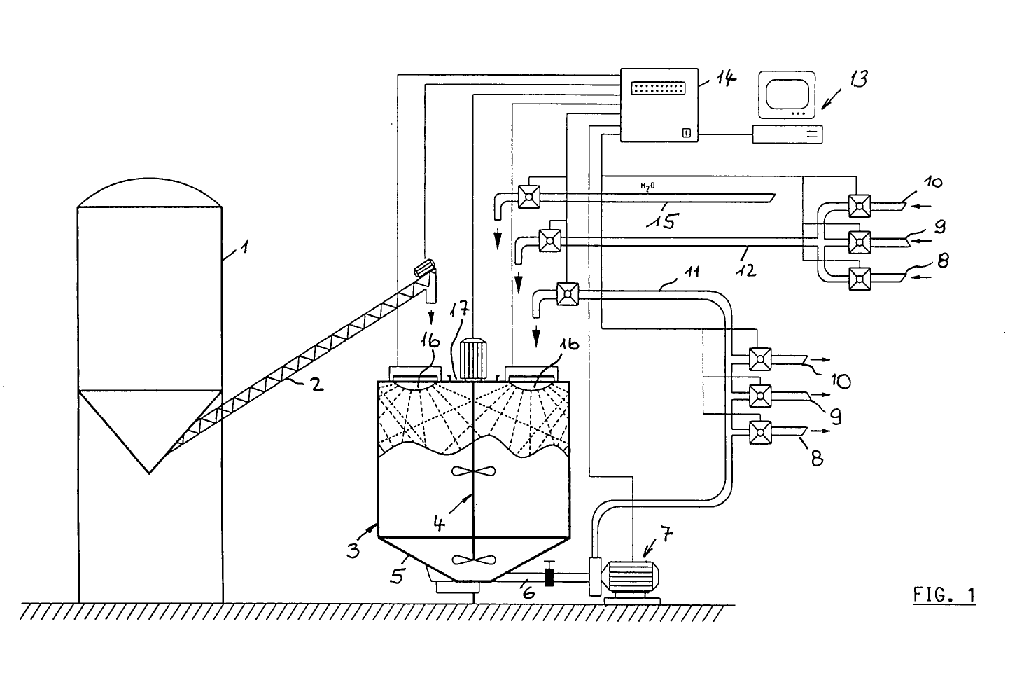

FIG. 1 an overview of a feeding device with feed mixing container according to the invention;

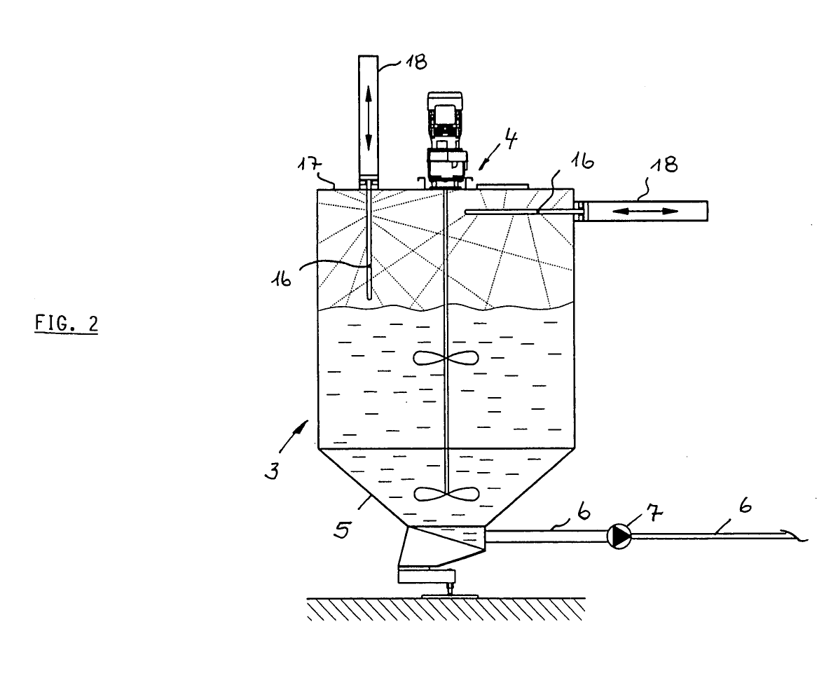

FIG. 2 a feed mixing container of a different embodiment; and

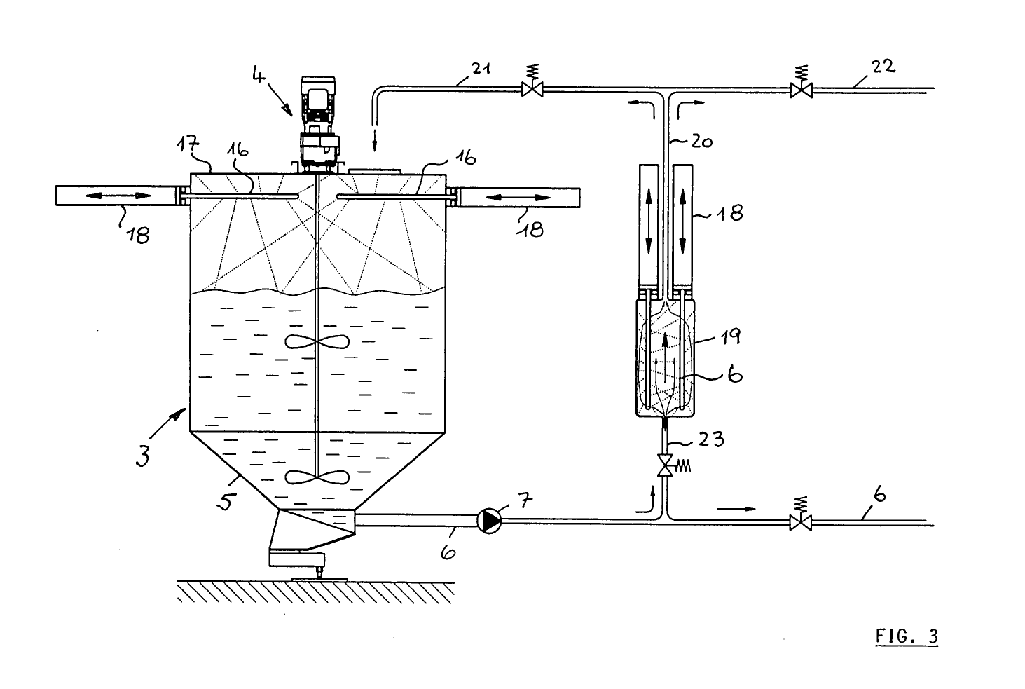

FIG. 3 a feeding device with a feed mixing container with continuous feed chamber arranged downstream.

The feeding device illustrated in the drawing, in particular, a feeding device for liquid feed, comprises silos 1 for feed components of which only one is illustrated. From these silos 1 feed components are transported by means of a conveying device 2 into a feed mixing container 3 that has an agitator 4 and is provided at the lower end of its funnel-shaped bottom 5 with a conveying conduit 6 through which, by means of a pump 7, a completely prepared feed mixture can be pumped via supply lines 8, 9, 10 to consumer locations.

The conveying conduit 6 can be returned with a section 11 to the feed mixing container 3 in order to be able to carry out recirculation of the feed, if desired. The supply lines 8, 9, 10 are preferably closed circuit pipelines that open at their end into a collecting pipeline 12 that, in turn, is returned to the feed mixing container 3. The feeding device is controlled by a central computer 13 that operates a central control device 14.

In addition to the feed components, the feed mixing container 3 can also be supplied by means of supply lines 15 with water or other liquid components such as whey.

The feed mixing container 3 is provided with at least one, preferably however several UV radiation sources 16 for a UV irradiation of the inner surfaces of the feed mixing container 3 and the surface of feed possibly present in the interior of the feed mixing container 3. The UV radiation sources 16 in the embodiment according to FIG. 1 are arranged on the cover 17 of the feed mixing container wherein the UV radiation sources 16 are preferably arranged at a uniform relative spacing about the central vertical container axis. The UV radiation which is preferably within the wavelength range of approximately 240 to 280 nanometers, preferably approximately 254 nanometers, causes germ killing so that before, during or after operation of the feed mixing container 3 germs contained therein and optionally contained in the feed mixture are reduced or eliminated, inasmuch as they are contacted by the UV radiation.

Instead of mounting the UV radiation sources on the cover 17, they can also be provided in the upper area of the container sidewall, as illustrated in FIG. 2 in a combination with a UV radiation source mounted on the cover 17, and as illustrated in FIG. 3.

In deviation from the UV radiation sources 16 in FIG. 1, the UV radiation sources 16 in FIGS. 2 and 3 have the shape of a rod member that can be moved by means of a pressure medium cylinder 18 from an operative position within the feed mixing container 3 into an inoperative position in which it is located at least partially outside of the container interior. The power of each rod member or each radiation source is expediently in the range of approximately 30 to 40 watt, preferably approximately 36 watt. Instead of pressure medium cylinders, other suitable drive means can also be used. In this connection, the UV radiation sources 16 illustrated in FIGS. 2 and 3 are movable in horizontal and/or vertical direction between their operative position and their inoperative position.

The feed mixing container 3 is provided in the wall passage area for the UV radiation source 16 with a seal (not illustrated) that upon movement of the UV radiation source 16 into its inoperative position acts as a stripping means and fulfills a cleaning function. A separate cleaning device (not illustrated), for example, formed of water jets, can be assigned to each UV radiation source 16 inside or outside of the feed mixing container 3 in order to remove contaminants that may have formed in operation. In special cases, it can also be provided for preventing contaminants that the UV radiation source 16 in the operative or inoperative position can be encapsulated or shielded by a cover relative to the environment. As a protection from mechanical impairments, the UV radiation source, for example, the rod members, can be provided with a quartz glass cover or envelope that allows unfiltered passage of UV radiation.

For enhancing the effectiveness of the UV radiation on the feed, the feed mixing container 3 can have arranged downstream thereof a continuous feed chamber 19 that can be continuously supplied by the conveying line 6 with the feed. In the arrangement according to FIG. 3, the continuous feed chamber 19 has at its outflow side a conveying line 20 that can supply a return line 21 to the feed mixing container 3 or a conveying line 22 that extends to the consumer locations. The supply side of the continuous feed chamber 19 is connected to a branch line 23 of the conveying conduit 6. In accordance with this arrangement, the continuous feed chamber 19 during circulation of the feed via the lines 6, 23, 20, 21 can be supplied with feed. Moreover, it can be supplied when the consumer locations are supplied with feed via lines 6, 23, 20, 22. However, it can also be disconnected from operation when supplying the consumer locations.

The continuous feed chamber 19 is provided at its interior with at least one, preferably however several, UV radiation sources 16 that can be moved axially out of the housing into the inoperative position by means of the pressure medium drive 18.

By means of the continuous feed chamber 19, an additional feed irradiation with UV light can be carried out by which the effect of the UV light on the feed is enhanced.

For securing the effectiveness of the UV radiation sources 16, the feed device, for example, the feed mixing container 3, can be provided with measuring sensors (not illustrated) with which, for example, the temperature, the pH value of the feed, the numbers of germs per volume unit, and similar parameters can be measured; this allows feedback with regard to the effectiveness of the irradiation. In this connection, the measuring sensors are connected to the central computer 13.

1-19. (canceled)

20. A feeding device comprising:
a feed mixing container comprising an agitator for mixing feed components and for circulating the feed components;
at least one UV radiation source arranged in an interior of the feed mixing container for UV irradiation of inner surfaces of the feed mixing container and of a surface of the feed components possibly present in the feed mixing container;
wherein the at least one UV radiation source emits a UV radiation in the range of approximately 240 to 280 nanometers, has a power draw of approximately 30 to 40 watt, and is provided with a protective quartz glass cover.

21. The feeding device according to claim 20, wherein several of the at least one UV radiation source are provided.

22. The feeding device according to claim 20, wherein the feed mixing container has a container cover and wherein the at least one UV radiation source is attached to the container cover.

23. The feeding device according to claim 20, wherein the at least one UV radiation source is arranged in an upper area of a container sidewall of the feed mixing container.

24. The feeding device according to claim 20, wherein several of the at least one UV radiation source are arranged at a uniform relative spacing to one another about a central vertical container axis of the feed mixing container.

25. The feeding device according to claim 20, wherein the at least one UV radiation source is moveable from an operative position within the feed mixing container into an inoperative position in which the at least one UV radiation source is at least partially outside of the interior of the feed mixing container.

26. The feeding device according to claim 25, wherein the feed mixing container has a wall passage area for the at least one UV radiation source and wherein a seal is arranged in the wall passage area, wherein the seal upon movement of the at least one UV radiation source into the inoperative position acts as a stripping means.

27. The feeding device according to claim 25, wherein the at least one UV radiation source has correlated therewith a separate cleaning device within or outside of the feed mixing container.

28. The feeding device according to claim 25, wherein the at least one UV radiation source is moveable in a horizontal direction or a vertical direction between the operative position and the inoperative position.

29. The feeding device according to claim 25, wherein the at least one UV radiation source in the operative position or in the inoperative position is encapsulated by the quartz glass cover relative to the environment.

30. The feeding device according to claim 20, wherein the at least one UV radiation source is a rod member.

31. The feeding device according to claim 20, wherein the at least one UV radiation source emits a UV radiation in the range of approximately 254 nanometers.

32. The feeding device according to claim 20, wherein the at least one UV radiation source has a power draw of approximately 36 watt.

33. The feeding device according to claim 20, further comprising a continuous feed chamber arranged downstream of the feed mixing container, wherein the the feed mixing container has a conveying conduit, connected to a bottom area of the feed mixing container and provided with a pump, wherein the continuous feed chamber is connected to the conveying conduit and is provided with at least one additional UV radiation source arranged within an interior of the continuous feed chamber, wherein the continuous feed chamber is supplied continuously with the feed components via the conveying conduit.

34. The feeding device according to claim 33, further comprising a conveying line connected to an outflow side of the continuous feed chamber, wherein the conveying line is configured to be alternatingly connected to a return line connected to the feed mixing container and a conveying line extending to consumer locations for conveying the feed components back to the feed mixing device or to the consumer locations.

35. The feeding device according to claim 33, wherein the conveying conduit extends directly to consumer locations and has a branch line that is connected to the continuous feed chamber.

36. The feeding device according to claim 20, further comprising a central computer, wherein at least one UV radiation source is controlled by the central computer, wherein the central computer also controls the feed mixing container and components and peripheral devices of the feed mixing container.

37. The feeding device according to claim 36, comprising measuring sensors provided for determining the effectiveness of the at least one UV radiation source, wherein the measuring sensors have an output connected to the central computer.
